(19) United States
(12) Patent Application Publication
(10) Pub. No.: US 2016/0376825 A1
(43) Pub. Date: Dec. 29, 2016

(54) METHOD OF PROVIDING A DEPICTION ON A DOMED SURFACE

(71) Applicant: Anthony Charles Rhodes, Durbanville (ZA)

(72) Inventor: Carl Emil Boje, Plattekloof (ZA)

(73) Assignee: Anthony Charles Rhodes, Durbanville (ZA)

(21) Appl. No.: 14/878,285

(22) Filed: Oct. 8, 2015

(30) Foreign Application Priority Data
Jun. 23, 2015 (ZA) ZA2015/04501

(51) Int. Cl. E05F 5/06; B41M 1/40

(52) U.S. Cl. CPC E05F 5/06; B41M 1/40

(57) ABSTRACT

A method of providing a depiction on a domed surface which is substantially symmetrical about a central axis is provided. The method comprises the steps of printing a depiction on a sheet of deformable material: supporting the sheet such that it extends generally symmetrically about the central axis of the domed surface and in a configuration that permits progressive contact with the domed surface; moving the sheet and domed surface relative to each other along the central axis of the domed surface such that the sheet progressively contacts the domed surface; and securing the sheet to the domed surface. The sheet is deformable in planar directions and held in position while the domed surface progressively contacts the sheet.

### CROSS-REFERENCE TO RELATED APPLICATIONS

The present application claims priority of South African Patent Application No. ZA2015/04501, filed Jun. 23, 2015, the content of which is incorporated herein by reference in its entirety.

### FIELD OF THE INVENTION

This invention relates to a method of providing a depiction on a domed surface. In particular it relates to a method of providing a printed depiction on a domed surface.

### BACKGROUND TO THE INVENTION

Printers are used to reproduce depictions such as text or images from a template onto a surface. Printing is a fast and efficient method of applying a depiction to an article allowing for mass production thereof. However, most commonly used printers are configured to print on planar surfaces only and not on irregular or shaped surfaces. In particular, a domed or concave surface may be cumbersome to print on.

In order to provide a depiction on a domed surface, the depiction may be printed on paper provided with an adhesive such a sticker which is then adhered to the domed surface, however, during the step of adhering the paper to the domed surfaces, unsightly creases may form in the paper which distort the depiction. Other methods of providing a printed depiction on a domed surface may be more complex and costly.

There is thus a need for a simple and relatively inexpensive method of providing a printed depiction on a domed surface that alleviates the abovementioned problems, at least to some extent.

### SUMMARY OF THE INVENTION

In accordance with the invention, there is provided a method of providing a depiction on a domed surface which is substantially symmetrical about a central axis, the method comprising the steps of: printing a depiction on a sheet of deformable material; supporting the sheet such that it extends generally symmetrically about the central axis of the domed surface and in a configuration which permits progressive contact with the domed surface when the sheet and domed surface are moved relative to each other: moving the sheet and domed surface relative to each other along the central axis of the domed surface such that the sheet progressively contacts the domed surface; and securing the sheet to the domed surface.

A further feature of the invention provides for he sheet to be supported in a generally planar configuration.

A yet further feature of the invention provides for the sheet to be supported in an oppositely domed configuration in which an apex of a dome of the sheet is oriented so as to be opposite to an apex of the domed surface.

Still further features of the invention provide for the sheet to be held in position whilst being supported and for the sheet to be deformable in planar directions.

A further feature of the invention provides for an adhesive to be applied to either he sheet or the domed surface in order to secure the sheet to the domed surface.

Yet further features of the invention provide for the method to include a step of covering the sheet secured to the domed surface with a transparent plastic material and securing the plastic material to the domed surface and for the plastic material to be secured to the domed surface by heat sealing.

Still further features of the invention provide for the method to include a step of cutting the sheet into a predetermined shape and size that is generally complementary to that of the domed surface prior to securing the sheet to the domed surface and for the shape of the sheet to be a circle having a diameter that is substantially proportional to a height of the domed surface

Further features of the invention provide for the step of supporting the sheet in a generally planar state to include placing the sheet onto a planar, deformable foam and for the domed surface to be pressed against the sheet and the foam such that both the sheet and foam deforms to accommodate the domed surface.

The invention extends to a doorstop manufactured in accordance with a method disclosed herein and to a dome-shaped doorstop having a flat base and a domed surface over which a sheet of a deformable material having a depiction printed thereon is secured. A further features provides for the doorstop to further comprise a transparent plastic material secured over the domed surface.

### BRIEF DESCRIPTION OF THE DRAWINGS

The invention will now be described, by way of example only, with reference to the accompanying representations in which:

FIG. 1 is a flow diagram that illustrates a method of providing a depiction on a domed surface in accordance with the invention;

FIG. 2 is a schematic illustration of a domed surface and a sheet of material supported on deformable foam;

FIG. 3 is a schematic illustration of a deformable foam having a domed upper surface which supports the sheet of deformable material in an oppositely domed configuration;

FIG. 4 is a schematic illustration of a doorstop with a domed surface onto which a sheet of deformable material and a plastic cover is secured; and,

FIG. 5 is a schematic illustration of a planar bottom surface of the doorstop of FIG. 3.

### DETAILED DESCRIPTION WITH REFERENCE TO THE DRAWINGS

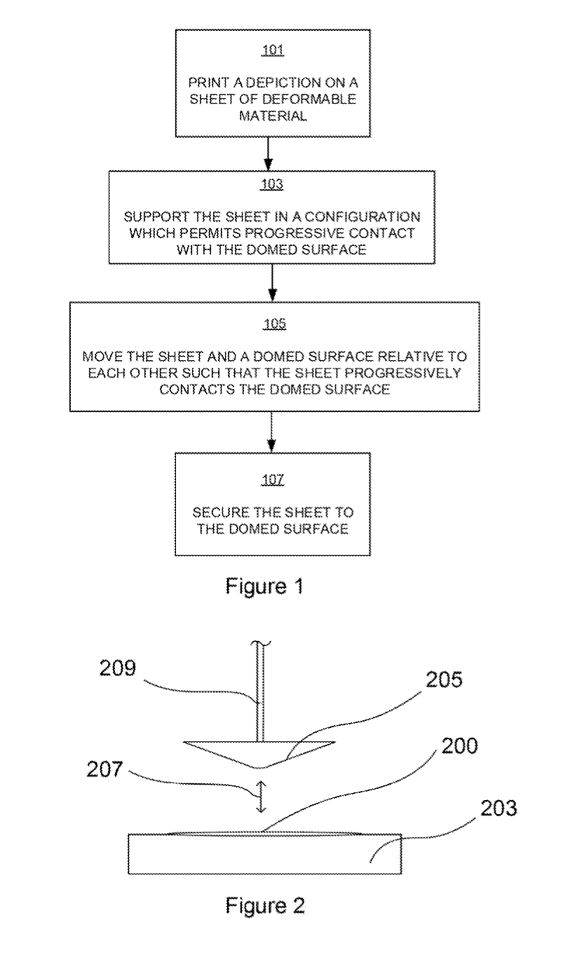

A method of providing a depiction on a domed surface which is substantially symmetrical about a central axis is illustrated in FIG. 1. At a first step (101), a depiction is printed on a sheet of deformable material. At a second step (103), the sheet is supported such that it extends generally symmetrically about the central axis of the domed surface and in a configuration which permits progressive contact with the domed surface when the sheet and domed surface are moved relative to each other. Next, the sheet and domed surface are moved relative to each other (105), so as to move toward one another along the central axis of the domed surface such that the sheet progressively contacts the domed surface. The sheet is then secured to the domed surface at a final step (107).

In one embodiment of the invention, the sheet is supported in a generally planar configuration so as to permit progressive contact with the domed surface when the sheet and domed surface is moved relative to each other. In a second embodiment of the invention, the sheet is supported in an oppositely domed configuration in which an apex of a dome of the sheet is oriented so as to be opposite to an apex of the domed surface.

The sheet is deformable in planar directions allowing the sheet of material to stretch slightly as it adapts to the shape of the domed surface. This deformability of the material ensures that the sheet is able to substantially cover the domed surface or a portion thereof regularly without creases forming in the sheet. The sheet is also held in position whilst being supported in the generally planar or oppositely domed configuration. An adhesive is applied to either the sheet or the domed surface in order to secure the sheet to the domed surface.

The method further includes a step of covering the sheet secured to the domed surface with a transparent plastic material and securing the plastic material to the domed surface by heat sealing. The plastic cover serves to protect the sheet and depiction from damage.

The sheet may be cut into a predetermined shape and size that is substantially complementary to the shape and size of the domed surface prior to securing the sheet to the domed surface. In an alternative embodiment of the method, the sheet may only be cut to size and shape after it has been secured to the domed surface. If, however, the cutting step is performed prior to securing the sheet to the domed surface which is generally symmetrical about a central axis and it is desired that the sheet must substantially cover the domed surface, the sheet may be cut into a circle having a diameter that is generally proportional to a height or degree of concavity of the domed surface.

In one embodiment of the invention illustrated in FIG. 2, a circular sheet (200) is supported in a generally planar configuration by placing the sheet onto a planar, deformable foam, preferably a block of elastically deformable foam (203). The upper surface of the sheet or the surface of the dome, or both, is covered with an adhesive. The arrow (207) shows the direction of movement of the domed surface (205) and sheet (200) and foam (203) assembly relative to one another to bring them closer together. In this embodiment, an arm (209) having a free end that is configured to engage with a complementary engagement formation on a surface of the object opposite the domed surface is provided. The arm is used to move and eventually press the domed surface (205) against the sheet and the foam such that both the sheet and foam deform to accommodate the domed surface. The arm (209) may be mechanically actuated and form part of an assembly mechanism in an industrial assembly line. As the domed surface progressively moves and presses against the sheet and foam, the sheet is held in relative position on the surface of the foam by frictional forces between the foam and the sheet that serves to grip the surface of the sheet that is in contact with the foam. While the sheet is held in position on the foam and in a planar state and the domed surface progressively presses against it, the sheet deforms in planar directions, in other words, stretches slightly. Due to the presence of the adhesive on the upper surface of the sheet, adherence of the sheet to the domed surface also occurs progressively. The progressive contact between the sheet and the domed surface as well as the material properties of the sheet making it capable of deformation are factors that allow the sheet to adhere to the domed surface without creases forming in the sheet.

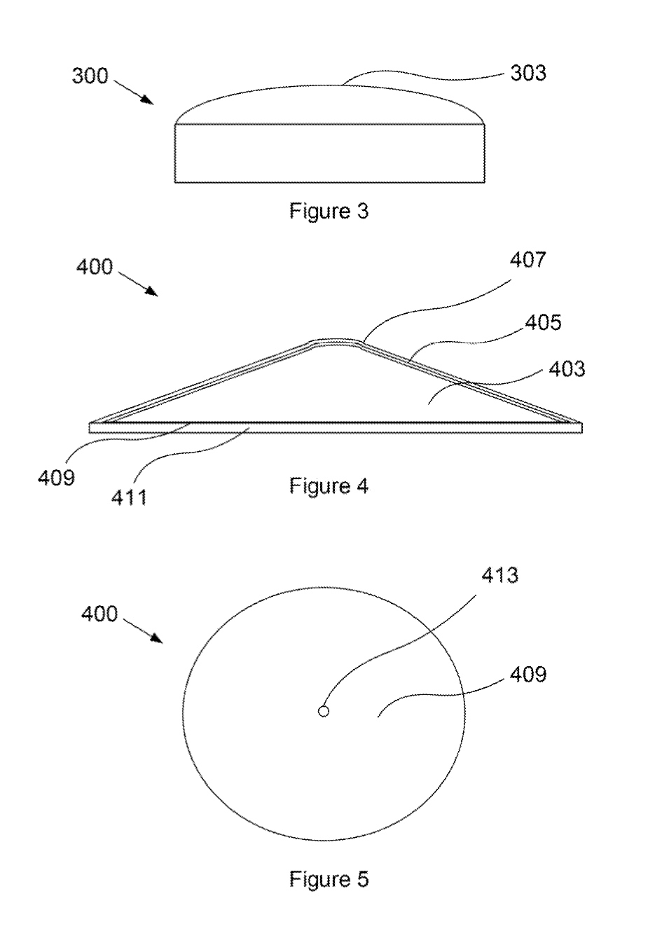

In an alternative embodiment of the invention, the sheet is supported on a deformable foam (300) having a domed upper surface (303) as shown in FIG. 3. The domed shape of the upper surface of the foam on which the sheet is supported ensures that the sheet is in an oppositely domed configuration in which an apex of a dome of the sheet is oriented so as to be opposite to an apex of the domed surface. Similar to a substantially planar configuration of the sheet, the oppositely domed configuration thereof permits progressive contact of the sheet with the domed surface when the sheet and domed surface are moved relative to each other.

The method of providing a depiction on a domed surface which is substantially symmetrical about a central axis may be used in the manufacture of doorstops for example. FIG. 4 is a schematic illustration of a doorstop (400) with a domed surface (403) onto which a sheet (405) of deformable material and a plastic cover (407) is secured. In this embodiment, the doorstop has a substantially conical shape defined by the upper domed surface (403) and a planar bottom surface (409). The doorstop includes a non-slip base (411) that may be made of a sheet of rubber which is adhered to the planar bottom surface (409).

FIG. 5 is a schematic illustration of the planar bottom surface of the doorstop (400) of FIG. 4. The bottom surface (409) defines a centrally located aperture (413) serving as a complementary engagement formation which is configured to receive and engage the arm (209) used to move the domed surface along its central axis when the domed surface is moved relative to the sheet to permit progressive contact between the domed surface and the sheet.

The sheet is preferably made of 4-way stretch polyester that is elastically deformable in orthogonal planar directions. The doorstop with the domed surface is preferably moulded from a suitably heavy polymeric material.

A doorstop such as the one shown in FIGS. 4 and 5 may be used in houses, offices, shops or the like to stop and hold a door open. In use, the domed surface of the doorstop of FIGS. 3 and 4 abuts against a lower edge of a door to stop and hold it open. A doorstop may form part of the interior decoration of a room and it may thus be desirable for the doorstop to have an aesthetically pleasing appearance as provided by a suitable depiction, such as an image, pattern, photograph or other design on the domed surface The upper domed surface of the doorstop may also be used to display information. For instance, a doorstop made in accordance with the invention may be a useful advertising and/or marketing tool for use in public places if the depiction on the doorstop displays a logo or other type of information.

The above description is by way of example only and it should be appreciated that numerous changes and modifications may be made to the method of providing a depiction on a domed surface without departing from the scope of the invention. For example, the sheet may be held in position and in a planar configuration which permits progressive contact with the domed surface by means of a frame that engages the periphery of the sheet instead of supporting it on a foam. The frame may be mounted so that the sheet is suspended so as to be normal to the central axis of the domed surface. In another embodiment of the invention, the sheet is held in position and in a planar configuration by a plurality of engagement assemblies such as clamps or the like that grip the sheet at opposite positions along its periphery. The sheet may also be held slightly or substantially taut.

it will be appreciated by those skilled in the art that various different means may be used to secure the sheet to the domed surface. For example, the sheet may be secured to the domed surface by stapling, nailing, clipping or stitching it to the domed surface or to the object with the domed surface. The most suitable method of securing the sheet to the domed surface may depend on the material properties of the object having the domed surface.

The method of providing a depiction on a domed surface may be applied to any suitable article having a domed surface and requiring surface decoration or requiring it to display information. Furthermore, the sheet and the domed surface may be made of any suitable material having the desired material properties, as long as the sheet is capable of deformation, preferably in planar directions.

It will also be appreciated that, instead of the step of printing the depiction on the sheet of deformable material being part of the method, the sheet of deformable material may be provided with the depiction having already been printed thereon.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method of providing a depiction on a domed surface which is substantially symmetrical about a central axis, the method comprising the steps of: providing a sheet of a deformable material having a depiction printed thereon; supporting the sheet such that it extends generally symmetrically about the central axis of the domed surface and in a configuration which permits progressive contact with the domed surface when the sheet and domed surface are moved relative to each other; moving the sheet and domed surface relative to each other along the central axis of the domed surface such that the sheet progressively contacts the domed surface; and securing the sheet to the domed surface.

2. The method as claimed in claim 1, wherein the sheet is supported in a generally planar configuration.

3. The method as claimed in claim 1, wherein the sheet is supported in an oppositely domed configuration in which an apex of the domed sheet is oriented so as to be opposite to an apex of the domed surface.

4. The method as claimed in claim 1, wherein the sheet is held in position whilst being supported.

5. The method as claimed in claim 1, wherein the sheet is deformable in planar directions.

6. The method as claimed in claim 1, wherein an adhesive is applied to the sheet or the domed surface in order to secure the sheet to the domed surface.

7. The method as claimed in claim 1, further including a step of covering the sheet secured to the domed surface with a transparent plastic material and securing the plastic material to the domed surface.

8. The method as claimed in claim 7, wherein the plastic material is secured to the domed surface by heat sealing.

9. The method as claimed in claim 1, further including a step of cutting the sheet into a predetermined shape and size that is generally complementary to that of the domed surface prior to securing the sheet to the domed surface.

10. The method as claimed in claim 9, wherein the shape of the sheet is a circle having a diameter that is generally proportional to a height of the domed surface

11. The method as claimed in claim 1 wherein the step of supporting the sheet includes placing the sheet onto a deformable foam.

12. The method as claimed in claim 11, wherein the domed surface is pressed against the sheet and the foam such that both the sheet and foam deforms to accommodate the domed surface.

13. The method as claimed in claim 1, wherein the step of providing sheet of the deformable material having the depiction printed thereon further includes of printing the depiction on the sheet of deformable material.

14. A doorstop having a domed surface with a depiction thereon manufactured in accordance with a method as claimed in claim 1.

15. A doorstop comprising a fiat base and a domed surface to which a sheet of a deformable material having a depiction printed thereon is secured.

16. The doorstop as claimed in claim 15, which further comprises a transparent plastic material secured over the domed surface.
